(19) United States
(12) Patent Application Publication
(10) Pub. No.: US 2004/0043494 A1
(43) Pub. Date: Mar. 4, 2004

(54) Apparatus for studying arrays

(76) Inventors: Douglas A. Amorese, Los Altos, CA (US); Laurence R. Shea, San Francisco, CA (US); Joseph P. Fredrick, Palo Alto, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/231,702

(22) Filed: Aug. 30, 2002

(51) Int. Cl. B01J 19/00

(52) U.S. Cl. 436/37; 436/180; 422/99; 422/102; 422/130; 422/131

(57) ABSTRACT

Apparatus and methods are disclosed for conducting chemical reactions. The apparatus comprises a plurality of wells in a housing and a channel in the housing. The channel surrounds the plurality of wells and is adapted for filling with an amount of a fluid to form a convex meniscus extending above the top of the channel. In the method one or more liquid samples are placed in separate wells in a housing surface comprising a plurality of the wells. The volume of the liquid sample in each of the wells is sufficient to form a convex meniscus at the surface of each of the wells. The liquid samples are contacted with a plurality of arrays of chemical compounds. In one approach, the liquid samples are contacted with a substrate surface having a plurality of arrays of chemical compounds arranged on the substrate surface. Each of the arrays corresponds to a respective well in the housing. As a result of the contact, the substrate surface compresses each convex meniscus without cross-contact between adjacent liquid samples.

### BACKGROUND OF THE INVENTION

This invention relates generally to an apparatus and methods for use in conducting chemical or biochemical reactions on a solid surface, as in hybridization assays in which surface-bound molecular probes selectively bind target molecules provided in a solution. The invention has utility in fields relating to biology, chemistry and biochemistry. The invention has particular application to the area of analyzing the results of hybridization reactions involving nucleic acids.

Determining the nucleotide sequences and expression levels of nucleic acids (DNA and RNA) is critical to understanding the function and control of genes and their relationship, for example, to disease discovery and disease management. Analysis of genetic information plays a crucial role in biological experimentation. This has become especially true with regard to studies directed at understanding the fundamental genetic and environmental factors associated with disease and the effects of potential therapeutic agents on the cell. Such a determination permits the early detection of infectious organisms such as bacteria, viruses, etc.; genetic diseases such as sickle cell anemia; and various cancers. New methods of diagnosis of diseases, such as AIDS, cancer, sickle cell anemia, cystic fibrosis, diabetes, muscular dystrophy, and the like, rely on the detection of mutations present in certain nucleotide sequences. This paradigm shift has lead to an increasing need within the life science industries for more sensitive, more accurate and higher-throughput technologies for performing analysis on genetic material obtained from a variety of biological sources.

Unique or misexpressed nucleotide sequences in a polynucleotide can be detected by hybridization with a nucleotide multimer, or oligonucleotide, probe. Hybridization reactions between surface-bound probes and target molecules in solution may be used to detect the presence of particular biopolymers. Hybridization is based on complementary base pairing. When complementary single stranded nucleic acids are incubated together, the complementary base sequences pair to form double stranded hybrid molecules. These techniques rely upon the inherent ability of nucleic acids to form duplexes via hydrogen bonding according to Watson-Crick base-pairing rules. The ability of single stranded deoxyribonucleic acid (ssDNA) or ribonucleic acid (RNA) to form a hydrogen bonded structure with a complementary nucleic acid sequence has been employed as an analytical tool in molecular biology research. An oligonucleotide probe employed in the detection is selected with a nucleotide sequence complementary, usually exactly complementary, to the nucleotide sequence in the target nucleic acid. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

Such reactions form the basis for many of the methods and devices used in the new field of genomics to probe nucleic acid sequences for novel genes, gene fragments, gene variants and mutations. The ability to clone and synthesize nucleotide sequences has led to the development of a number of techniques for disease diagnosis and genetic analysis. Genetic analysis, including correlation of genotypes and phenotypes, contributes to the information necessary for elucidating metabolic pathways, for understanding biological functions, and for revealing changes in genes that confer disease. Many of these techniques generally involve hybridization between a target nucleotide sequence and a complementary probe, offering a convenient and reliable means for the isolation, identification, and analysis of nucleotides. The surface-bound probes may be oligonucleotides, peptides, polypeptides, proteins, antibodies or other molecules capable of reacting with target molecules in solution.

Direct detection of labeled target nucleic acid hybridized to surface-bound polynucleotide probes is particularly advantageous if the surface contains a mosaic of different probes that are individually localized to discrete, known areas of the surface. Such ordered arrays containing a large number of oligonucleotide probes have been developed as tools for high throughput analyses of genotype and gene expression. Oligonucleotides synthesized on a solid support recognize uniquely complementary nucleic acids by hybridization, and arrays can be designed to define specific target sequences, analyze gene expression patterns or identify specific allelic variations.

In one approach, cell matter is lysed, to release its DNA as fragments, which are then separated out by electrophoresis or other means, and then tagged with a fluorescent or other label. The resulting DNA mix is exposed to an array of oligonucleotide probes, whereupon selective attachment to matching probe sites takes place. The array is then washed and imaged so as to reveal for analysis and interpretation the sites where attachment occurred.

One typical method involves hybridization with probe nucleotide sequences immobilized in an array on a substrate having a surface area of typically less than a few square centimeters. The substrate may be glass, fused silica, silicon, plastic or other material; preferably, it is a glass slide, which has been treated to facilitate attachment of the probes. The mobile phase, containing reactants that react with the attached probes, is placed in contact with the substrate, covered with another slide, and placed in an environmentally controlled chamber such as an incubator. Normally, the reactant targets in the mobile phase diffuse through the liquid to the interface where the complementary probes are immobilized, and a reaction, such as a hybridization reaction, then occurs. Preferably, the mobile phase targets are labeled with a detectable tag, such as a fluorescent tag, or chemiluminescent tag, or radioactive label, so that the reaction can be detected. The location of the signal in the array provides the target identification. The hybridization reaction typically takes place over a time period of up to many hours. During this time, the solution between the glass plates has a tendency to dry out through evaporation along the edges of the slide-slide contact.

Such “biochip” arrays have become an increasingly important tool in the biotechnology industry and related fields. These binding agent arrays, in which a plurality of binding agents are synthesized on or deposited onto a substrate in the form of an array or pattern, find use in a variety of applications, including gene expression analysis, drug screening, nucleic acid sequencing, mutation analysis, and the like. Substrate-bound biopolymer arrays, particularly oligonucleotide, DNA and RNA arrays, may be used in screening studies for determination of binding affinity and in diagnostic applications, e.g., to detect the presence of a nucleic acid containing a specific, known oligonucleotide sequence.

The pattern of binding by target molecules to biopolymer probe spots on the biochip forms a pattern on the surface of the biochip and provides desired information about the sample. Hybridization patterns on biochip arrays are typically read by optical means, although other methods may also be used. For example, laser light in the Hewlett-Packard GeneArray Scanner excites fluorescent molecules incorporated into the nucleic acid probes on a biochip, generating a signal only in those spots on the biochip that have a target molecule bound to a probe molecule, thus generating an optical hybridization pattern. This pattern may be digitally scanned for computer analysis. Such patterns can be used to generate data for biological assays such as the identification of drug targets, single-nucleotide polymorphism mapping, monitoring samples from patients to track their response to treatment, and assess the efficacy of new treatments.

Control of the reaction environment and conditions contributes to increased reliability and reproducibility of the hybridization reactions. Reducing the volume of the chamber, and therefore increasing the concentration of reactants, increases the sensitivity of the assay.

However, merely placing one slide over another or positioning a cover slip on a slide, as is commonly done, is often insufficient to allow precise control over reaction temperature, duration, mixing, and other reaction parameters. For these reasons, efficient reaction chamber design can improve the results achieved with hybridization techniques.

During hybridization, which is often performed at elevated temperatures, care must be taken that the array does not dry out. Merely placing one slide over another or positioning a cover slip on a slide allows contents to leak or dry out during use, adversely affecting the reaction. In addition, the substrate cannot be tipped from the horizontal without risking that the slide or cover slip will slide off. Maintaining a biochip in a humid environment may reduce drying-out, but offers only an incomplete solution. Secondary containment of the solution, as from applying sealant around the edges of the cover over the array, or enclosing the substrate and cover in a closed assembly, may reduce drying-out but is labor-intensive and time-consuming. In addition, in order to result in optimal hybridization, all parts of the array must be contacted by a liquid with uniformly distributed reactants. If the solution dries out, or is not mixed, different portions of the array will be bathed in different concentrations of reactants, impairing the ability to accurately assess the sample.

Various general approaches have been employed for carrying out hybridization reactions on supports or substrates with one or more arrays on a surface. One such approach involves the generation of an array on the bottom of a flat bottom microtiter plate. Another approach involves gluing (or attaching) of a substrate with an array on it to a microtiter plate lacking a bottom where the substrate forms the bottom of the microtiter plate. Still another approach includes the use of a gasket with inlets and outlets (and pressure) to section off portions of the substrate containing individual arrays.

It is possible to pre-fabricate the chamber and array before use, and so improve the uniformity of the apparatus, as described, for example, in co-pending, commonly assigned U.S. Pat. No. 6,261,523 (Schembri) (Jul. 17, 2001) entitled “Adjustable Volume Sealed Chemical-Solution-Confinement Vessel.” The patent describes a chamber formed by bonding a glass substrate into a plastic package. However, such a custom-designed package requires specialized processing equipment, and so cannot be used with arrays produced by a laboratory or by sources of generic arrays.

It is possible to contain fluids and reduce drying out in a hybridization or other reaction chamber by providing an O-ring or gasket material between the substrate and cover. However, typical O-rings are about 1.5 to 1.8 mm thick. The O-ring or gasket material would be exposed to the reactants and buffers and may have a deleterious effect on the assay through leaching of contaminants into the reaction chamber and through removal of target molecules out of the reaction chamber by non-specific binding.

A method for single well addressability in a sample processor with row and column feeds is disclosed in U.S. Pat. No. 6,395,559 (Swenson) (May 28, 2002). A sample processor or chip has a matrix of reservoirs or wells arranged in columns and rows. Pressure or electrical pumping is utilized to fill the wells with materials.

Inadequate mixing is a particular problem in chemical and biological assays where very small samples of chemical, biochemical, or biological fluids are typically involved. Inhomogeneous solutions resulting from inadequate mixing can lead to poor hybridization kinetics, low efficiency, low sensitivity, and low yield. With inadequate mixing, diffusion becomes the only means of transporting the reactants in the mobile phase to the interface or surface containing the immobilized reactants. In such a case, the mobile phase can become depleted of reactants near the substrate as mobile molecules become bound to the immobile phase. Also, if the cover is not exactly parallel to the plane of the substrate, the height of the fluid film above the probe array will vary across the array. Since the concentration of target molecules will initially be constant throughout the solution, there will be more target molecules in regions where the film is thicker than in regions where it is thinner, leading to artifactual gradients in the hybridization signal.

Thus, problems associated with hybridization under a cover include drying out of the sample (unless the solution is carefully contained and the humidity of the environment precisely controlled), the need for secondary containment, the inability to ensure that the fluid thickness is uniform across the array, and the inability to mix the solution during hybridization.

Methods for mixing relatively large volumes of fluids usually utilize conventional mixing devices that mix the fluids by shaking the container, by a rapid mechanical up and down motion, or by the use of a rocking motion that tilts the container filled with the fluids in a back and forth motion. The conventional mixing methods normally cannot be utilized for thin films of fluid because the capillary strength of the containment system often significantly exceeds the forces generated by shaking or rocking, thereby preventing or minimizing fluid motion in the film. This is because most or all of the fluid is so close to the walls of the chamber that there is virtually no bulk phase, so that surface interactions predominate.

Sample binding to spots on biochip arrays is commonly assessed by optical means, although other methods may also be used. Non-specific optical signals, which may arise due to non-specific binding of targets, irregularities or debris on the substrate, or for other reasons, interferes with the accurate analysis of the sample. High background reduces contrast, making it harder to identify spots bound with target molecules, leading to false negative signals. Spurious spots caused by background effects yield false positives signals, by indicating binding where there is none. Thus, high background signals present problems in the acquisition and analysis of optical signals generated by biochip arrays.

Accordingly, there is a need in the art for an improved apparatus and methods for conducting chemical or biochemical reactions on a solid substrate within a thin enclosed chamber, wherein mixing of components is facilitated despite the small volume of the chamber, and further wherein the occurrence of unintended chemical reactions is substantially reduced. It is also desirable that the apparatus and methods be such that a sample can be contained for extended times at elevated temperatures with little or no evaporation and without the requirements of secondary containment or humidity control. The apparatus and methods should be relatively inexpensive, have little or no leakage, avoid the use of adhesives, avoid the use of large sample volumes, and not be limited to small numbers of arrays that may be processed.

### SUMMARY OF THE INVENTION

One embodiment of the present invention is an apparatus for conducting chemical reactions. The apparatus comprises a plurality of wells in a housing and a channel in the housing. The channel surrounds the plurality of wells and is adapted for filling with an amount of a fluid to form a convex meniscus extending above the top of the channel.

Another embodiment of the present invention is a method for conducting chemical reactions. One or more liquid samples are placed in separate wells in a housing surface comprising a plurality of the wells. The volume of the liquid sample in each of the wells is sufficient to form a convex meniscus at the surface of each of the wells. The liquid samples are contacted with a plurality of arrays of chemical compounds. In one approach, the liquid samples are contacted with a substrate surface having a plurality of arrays of chemical compounds arranged on the substrate surface. Each of the arrays corresponds to a respective well in the housing. As a result of the contact, the substrate surface compresses each convex meniscus without cross-contact between adjacent liquid samples.

Another embodiment of the present invention is a method of testing multiple liquid samples with multiple biopolymer arrays. Each of the multiple liquid samples is placed in all or less than all of the separate wells in a housing surface comprising a plurality of the wells. The volume of the liquid sample in each of the wells is sufficient to form a convex meniscus at the surface of each of the wells and the bottom of the wells is slanted. Liquid is placed in a channel in the housing surface surrounding the wells wherein the amount of the liquid is sufficient to form a convex meniscus. The liquid samples are contacted with a substrate surface having multiple biopolymer arrays arranged on the substrate surface. Each of the arrays corresponds to a respective well in the housing. The substrate surface compresses each convex meniscus without cross-contact between adjacent liquid samples. In addition, a seal is formed between the substrate surface and the housing surface around the perimeter of the wells. Heat is applied to the liquid samples sufficient to cause circulation in the samples. The substrate surface is then observed for the presence of reactions between the biopolymer arrays and the liquid samples.

Another embodiment of the present invention is a kit for analyzing multiple biopolymer arrays on the surface of a substrate. The kit comprises in packaged combination an apparatus for conducting chemical reactions and a substrate having on a surface thereof a plurality of biopolymer arrays. The apparatus comprises a plurality of wells in a housing and a channel in the housing. The channel surrounds the plurality of wells and is adapted for being filled with an amount of a fluid to form a convex meniscus extending above the top of the channel.

Another embodiment of the present invention is a method for conducting chemical reactions. One or more liquid samples is placed in separate wells in a housing surface comprising a plurality of the wells wherein each of the wells has a depth which varies within the well. The liquid samples are contacted with a plurality of arrays of chemical compounds wherein each of the arrays corresponds to a respective well in the housing. In one approach, the liquid samples are contacted with a substrate surface placed over the well openings where the surface has the plurality of arrays of chemical compounds arranged on the substrate surface.

### BRIEF DESCRIPTION OF THE DRAWINGS

FIG. 1 is a schematic depiction of a portion of an apparatus in accordance with the present invention.

FIG. 2 is a cross-sectional view of the apparatus of FIG. 1 taken along lines 2-2 with a substrate disposed over the wells of the apparatus.

FIG. 3 is a cross-sectional view of the apparatus of FIG. 1 showing certain wells overfilled with liquid samples in accordance with the present invention and a sealing liquid in a channel around the perimeter of the apparatus.

FIG. 4 is a cross-sectional view of the apparatus of FIGS. 1 and 3 showing a substrate disposed thereover with contact between arrays on the surface of the substrate and liquid samples in the wells as well as contact between the perimeter of the substrate and the sealing liquid in a channel around the perimeter of the apparatus of FIG. 1 in accordance with the present invention.

FIG. 5 is a depiction is cross-section of another embodiment of an apparatus in accordance with the present invention wherein the wells of the apparatus have slanted bottoms.

FIG. 6 is a depiction in cross-section of the apparatus of FIG. 5 wherein liquid samples are in some of the wells of the apparatus and a sealing liquid is in a channel around the perimeter of the apparatus.

FIG. 7 is a depiction in cross-section of the apparatus of FIGS. 5 and 6 showing a substrate disposed thereover with contact between arrays on the surface of the substrate and liquid samples in the wells as well as contact between the perimeter of the substrate and the sealing liquid in a channel around the perimeter of the apparatus in accordance with the present invention. Also shown in FIG. 7 is a heating apparatus disposed below the apparatus of FIGS. 5 and 6.

FIG. 8 is a depiction in cross-section of the apparatus of FIGS. 5 and 6 showing a substrate disposed thereover with contact between arrays on the surface of the substrate and liquid samples in the wells as well as contact between the perimeter of the substrate and the sealing liquid in a channel around the perimeter of the apparatus in accordance with the present invention. Also shown in FIG. 7 is a heating source comprising infrared targets disposed in the wells of the apparatus and infrared sources disposed below the apparatus of FIGS. 5 and 6.

FIG. 9 is a depiction in cross-section of the apparatus of FIGS. 5 and 6 showing a substrate disposed thereover with contact between arrays on the surface of the substrate and liquid samples in the wells as well as contact between the perimeter of the substrate and the sealing liquid in a channel around the perimeter of the apparatus in accordance with the present invention. Also shown in FIG. 7 is a heating source comprising radio frequency targets disposed in the wells of the apparatus and a radio frequency source disposed below the apparatus of FIGS. 5 and 6.

FIG. 10 is a depiction is cross-section of another embodiment of an apparatus in accordance with the present invention, which is similar to the apparatus of FIG. 1 with a groove surrounding each of the wells of the apparatus.

FIG. 11 is a perspective view of a substrate bearing multiple arrays.

FIG. 12 is an enlarged view of a portion of FIG. 11 showing some of the identifiable individual regions (or “features”) of a single array of FIG. 11.

FIG. 13 is an enlarged cross-section of a portion of FIG. 12.

### DESCRIPTION OF THE SPECIFIC EMBODIMENTS

In a broad aspect the present invention concerns apparatus and methods for processing as few as one array per substrate or well housing or tens, hundreds or more arrays per substrate or well housing. Thus, the present apparatus and methods have extreme flexibility. The number of arrays processed is dependent on the number of wells in a multiple well device that are filled with liquid samples. In one embodiment the number of arrays processed is dependent also on the number of arrays per substrate. In the present invention each well that is to be filled is overfilled with a liquid sample. Accordingly, the arrays may be on a substrate or in the wells of the well housing. The substrate, either having a substrate surface on which the array(s) are disposed or not, is placed over or on top of liquid samples in the wells effectively forming individual reaction chambers. The substrate essentially floats on the liquid samples in the wells. The geometry of the wells defines the volume of liquid sample in the wells. The wells are overfilled with liquid sample so that contact is made between the liquid samples and the individual arrays on the substrate surface where the substrate surface comprises the individual arrays.

A further feature that may be employed is a seal around the perimeter of the wells that prevents or reduces evaporation of the liquid samples. In one approach the seal is achieved using a narrow channel that runs around the perimeter of the housing of the wells. This channel is overfilled with a solution containing a liquid that reduces the rate of evaporation of the solution. As evaporation of the solution might occur, the concentration of the liquid in the solution increases counteracting, and thus reducing, the rate of evaporation. Following the reactions the solution is readily removed during any washing step.

Another feature that may be employed in conjunction with the above is the use of a sloped bottom in each well, which may be employed in bringing about mixing of the liquid samples during contact with the arrays on the substrate surface. In one approach a heat source is employed to promote circulation in the liquid samples. The heat source is usually aligned with the deepest edge of each well having a slanted bottom. When heat is applied, the liquid sample closest to the heat source changes density and rises whereas solution in the cooler portion of the liquid sample, which is usually at the top of the well, is drawn lower (toward the heat source) where it is heated. In this way a fluid flow or convection is created.

As mentioned above, one embodiment of the present invention is an apparatus for conducting chemical reactions as discussed more fully below. The present apparatus comprise a plurality of wells in a housing. The housing can be made from any material that is compatible with the chemical reactants and solvents that are placed in the wells of the housing. Any of a variety of organic or inorganic materials or combinations thereof, may be employed for the housing including, for example, plastics, such as polypropylene, polystyrene, polyvinyl chloride, etc.; nylon; PTFE, ceramic; silicon; (fused) silica, quartz or glass, and the like. The housing may be of any shape, but usually the shape and size of the housing are similar to that of the substrate. The shape of the housing may be, for example, rectangular, square, circular, oval, and so forth. The dimensions of the housing are sufficient to allow for a desired number of wells of predetermined size to be incorporated into the housing. The wells are formed in the housing by machining, molding, embossing, stamping and the like. Usually, the dimensions of the housing are about 10 mm to about 400 mm in length, about 10 mm to about 400 mm in width, and about 0.25 mm to about 25 mm in depth, more usually, about 25 mm to about 305 mm in length, about 25 mm to about 305 mm in width, and about 1 mm to about 15 mm in depth. By way of illustration and not limitation, some examples of typical dimensions for length and width, which approximate dimensions of substrates, are about 25 mm by about 25 mm, about 25 mm by about 76 mm, about 50 mm by about 50 mm, about 76 mm by about 76 mm, about 152 mm by about 152 mm, about 305 mm by about 305 mm, about 85 mm by about 125 mm.

The number of wells in the housing is normally at least as great as the number of arrays on the substrate, but need not be. The spatial arrangement of the wells may be in an array format that corresponds to the array arrangement of a substrate having a surface with an array of arrays. The wells are generally coplanar with the surface of the housing in which the well openings are arranged. The planar opening of the wells may be of any shape such as, for example, rectangular, square, circular, oval, elliptical, rectangular or square with radiused corners and so forth. The bottom of the wells may be level or slanted as discussed more fully herein. The planar dimensions of the opening of the wells are dependent on the planar dimensions of the array on the facing substrate aligned with the well opening. Usually, the planar dimensions of the well openings are about 0.5 mm to about 40 mm in length and about 0.5 mm to about 40 mm in width, more usually, about 1 mm to about 30 mm in length and about 1 mm to about 30 mm in width. By way of illustration and not limitation, some examples of typical planar dimensions for length and width are about 23 mm by about 54 mm, about 23 mm by about 29 mm, about 6 mm by about 23 mm, about 10 mm by about 13 mm. The volume capacity of the wells is usually about 100 nL to about 300 μL, more usually, about 1 μL to about 100 μL. In one embodiment, the housing with the wells is similar to a standard microtiter plate, which is used for high throughput analysis, such as, for example a 24-, 96-, 256-, 384-, 864- or 1536-well plate.

A number of approaches for avoiding contact between or among liquid samples in each well are discussed next by way of illustration and not limitation. In one approach each well is surrounded by a groove or moat to assist in containing liquid samples in individual separate wells by capillary action. The discontinuity at the edge of the groove impedes capillary flow. The shape, dimensions and placement of the groove are dependent on the nature of the liquid sample, its contact angle, the hydrophobicity of the groove material or the groove surface and so forth. The main consideration of the shape of the groove is that its edges be sufficiently sharp to impede capillary flow. Thus, the edges should be at or near right angles. By the phrase “near right angle” is meant about 90 to about 95 degrees. The cross sectional shape of the groove may be, for example, rectangular, or square with straight sides and a flat, concave or convex bottom. The dimensions of the groove may be, for example, 0.1 mm to about 5 mm deep and about 0.25 mm to 5 mm wide, more usually about 3 mm deep and 1 mm wide. Usually, the groove is placed within about 0.5 mm to about 2 mm, more usually, about 0.5 mm to about 1 mm, from the edge of the well.

In another approach for avoiding contact among the liquid samples in the wells, the surface properties surrounding each of the wells is different than the surface properties of the interior of the wells. In one aspect of this approach, the interior surface of the well is rendered hydrophilic such as by coating the interior with a hydrophilic material and at least the exterior shoulder of the well is rendered hydrophobic such as by coating the exterior shoulder with a hydrophobic material. This approach may be used in conjunction with the use of a groove around each well as discussed above. Thus, the area between the groove and the well is rendered hydrophobic. The use of hydrophilic and hydrophobic surface treatments may be extended to pattern the entire surface of the well housing comprising the well openings either with or without the use of a groove surrounding each well opening. Hydrophobic treatments involve materials such as plastics, silanized glass, fused silica, and so forth. It is also within the purview of the invention to make the surface of the substrate carrying the arrays hydrophobic between the arrays on the surface in order to further avoid contact among liquid samples in the wells when the substrate is placed in contact with the liquid samples in the wells.

It is desirable to have a fluid seal between the perimeter of the surface of the substrate comprising the arrays and the surface of the well housing comprising the well openings. Various approaches may be employed. In one approach, the well housing comprises a channel that surrounds the plurality of wells. The channel is adapted for filling with an amount of a fluid to form a convex meniscus extending above the top of the channel. The channel is overfilled with a fluid, usually a liquid, thus providing a seal when a substrate is placed adjacent to the housing surface and in contact with the liquid in the channel. The channel surrounds at least all of the wells that are to be in contact with the surface of the substrate carrying the arrays. Usually, the channel is near the perimeter of the housing surface comprising the wells. The location of the channel from an edge of the housing surface is usually about 1 mm to about 10 mm. The dimensions of the channel are dependent on a number of factors such as, for example, dimensions of the housing, operating temperature and vapor pressure of the liquids contained in the wells and so forth. Usually, the dimensions of the channel are 1 mm to about 5 mm deep and about 1 mm to 5 mm wide, more usually, about 3 mm deep and about 3 mm wide. The channel may be formed in the housing by any standard technique such as, for example, extrusion, molding, embossing, stamping, machining and the like.

As mentioned above, the channel is overfilled with a liquid. Generally, the amount of liquid in the channel is such that a convex meniscus is formed extending above the surface of the housing immediately adjacent the channel. Accordingly, the amount of liquid should not be so great as to overcome surface tension of the liquid at the surface. The amount of liquid is dependent on a number of factors such as, for example, the dimensions of the channel, the nature of the liquid, the surface properties of the housing adjacent the channel, and so forth. Usually, the amount of liquid in the channel is determined by the volume of the channel plus the volume of the desired meniscus. As an example, the volume of the channel equals its height times its width times its length. Added to this volume is the meniscus volume which may be approximated as width of the channel times the length of channel times the spacing between the housing and the substrate times the fill-factor, where the fill factor is about 0.5 to 0.9.

The nature of the fluid in the channel is determined primarily by its ability to form the desired convex meniscus and its ability to form a seal when in contact with a surface of a substrate where the weight of the substrate assists in forming the seal. The seal must by sufficient to substantially reduce or eliminate the rate of evaporation of liquid samples placed in the wells of the housing. Usually, the fluid is an aqueous media, which may contain a substance that reduces the rate of evaporation of the liquid media. Such substances should have low rates of evaporation and include polyethers, particularly polyethers having a molecular weight in the range of about 200 to about 200,000, such as, for example, polyethylene glycol, polypropylene glycol, and so forth or polyols, such as, for example, carboxymethylcellulose, hydroxypropyl cellulose or polyvinylalcohol, and the like. The aqueous mixture containing the substance should be of such a nature that, as water evaporates from the fluid seal, the concentration of the substance thus increases counteracting and reducing the rate of evaporation. The amount of the substance in the aqueous mixture is generally sufficient to reduce the overall rate of evaporation while maintaining the fluid seal. Usually, the substance is present in the aqueous mixture in the amount of about 0.005% to about 100%, more usually, about 0.01% to about 5%.

Another approach for forming a fluid seal between the perimeter of the surface of the substrate comprising the arrays and the surface of the well housing comprising the well openings involves the use of a flexible member. This approach may be feasible under certain circumstances where the thickness of the flexible member is not a problem or where there is no deleterious effect on the liquid samples from the flexible member material. The overfilling of the wells with liquid sample without contact among the samples as used in the present invention may permit the use of a flexible member and still avoid the problems associated with the use of gaskets as known in the art and as explained above. The flexible member is usually a gasket and may be in any shape such as, for example, circular, oval, rectangular, and the like. Preferably, the flexible member is in the form of an O-ring. The flexible member may be, for example, rubber, flexible plastic, flexible resins, and the like and combinations thereof. In any event the flexible material should be substantially inert with respect to the liquid samples in the wells.

The present apparatus may comprise a fluid circulation mechanism for circulating liquid samples contained in the wells and, thus, provide for mixing in the liquid samples. The fluid circulation mechanism may be source of a thermal gradient or a source of mechanical energy.

In one approach the bottom of each of the wells is sloped or slanted so that the depth at one end, edge or point of the well is different than the depth at another end, edge or point of the well. This mechanism also includes a means for providing a convective fluid flow within the wells having the slanted bottoms. In one embodiment a heat source is employed usually impacting the liquid at the deeper part of the well. When heat is applied, liquid in the cooler portion of the well is drawn lower toward the warmer area, thus creating the desired convective fluid flow. A number of approaches that provide for spot or area heating within the well may be employed for the heat source. In one approach a heating unit may be employed where the unit comprises a plurality of heating elements corresponding in number to the number of wells in which convective fluid flow is desired. The heating elements are arranged in a housing of the heating unit so that they are near the deeper area of the respective wells when the heating unit is placed in position adjacent the surface of housing opposite the surface comprising the well openings.

The housing for the heating unit is usually constructed from any material that is compatible with the function of the heating elements. Preferably, the material provides for thermal insulation surrounding each of the heating elements to isolate the heating elements from one another. Thus, the entire housing may be constructed from the thermally insulating material or only the areas of the housing surrounding each of the heating elements may be constructed of the thermally insulating material. The material for the heating unit housing includes inorganic materials such as glass, silica, fused silica, magnesium sulfate, and alumina; natural polymeric materials, synthetic or modified naturally occurring polymers, such as poly (vinyl chloride), polyacrylamide, polyacrylate, polyethylene, polypropylene, poly(4-methylbutene), polystyrene, polymethacrylate, poly(ethylene terephthalate), nylon, poly(vinyl butyrate), etc.; either used by themselves or in conjunction with other materials, ceramics, metals, and the like.

The housing of the heating unit can have any one of a number of shapes, such as a circle, square, rectangle, triangle, strip, plate, disk, rod, particle, including bead, and the like. Usually, the shape corresponds to the shape of the housing comprising the wells. However, this need not be the case as long as the arrangement of the heating elements in the heating unit housing corresponds with the arrangement of the wells in the well housing. In a preferred embodiment the housing of the heating unit is rectangular and substantially planar.

The heat generating elements of the heating unit may be any heat source that is capable of providing heat. The heat generating elements may be responsive to an electrical impulse. The heat generating elements may be, for example, resistors, electrical resistance heater, semiconductor junction elements such as those based on the Peltier effect such as a Peltier-effect thermoelectric element, and the like.

Other methods to achieve spot or local heating within each well include embedding a high emissivity (flat-black target) in the bottom of each well. The target is illuminated with high-intensity infrared radiation. The target absorbs the infrared energy causing the target to heat. Contact between the liquid in the wells allows the heat to be transferred to the liquid, thus creating the desired convection current in the liquid in the wells. The target may be made of any material that absorbs infrared energy and heats as a result. Such materials include, for example, metal, thermally conductive plastics or ceramics and the like. Preferably, the infrared radiation is supplied through the housing surface that is opposite from the surface comprising the openings for the wells. Usually, the radiation is supplied from below the housing comprising the wells to minimize exposure of the liquid samples in the wells to the radiation and, thus, to avoid deleterious effects on the liquid samples, which may comprise sensitive polynucleotide, polypeptide or other substances. The infrared source may be scanned across the wells or individual sources of infrared radiation may be employed using a pulsing on/off approach to create convective flow in the liquid samples. The source of the infrared radiation may be, for example, an infrared laser, a high intensity infrared LED, heat-lamp or incandescent radiation source, and so forth.

In another approach a target is embedded in the vertical side wall of each well. The target is then heated by means of a radio frequency (RF) induction coil located below the chamber assembly. The RF energy induces eddy current to flow within the target. The energy is converted to heat, which is transferred to the liquid sample in the well causing a convective flow pattern. The target may be constructed of any material that absorbs radio frequency energy and produces heat. Such materials include, for example, ferrous metals and the like.

In another approach heat sources are employed both above and below the wells, that is, from both sides of the surfaces of the well housing. The variation should be sufficient to achieve the convective fluid flow in the liquid samples in the wells. The variation is usually greater than about 1 degree C., more usually, greater than about 5 degrees C. The upper limit on the variation is usually about 20 degrees C.

The fluid circulation mechanism may involve the use of an electrical current to circulate liquid samples in the wells. For example, an electrode composed of a conductive material such as platinum metal, gold, conductive carbon, and the like) may be placed adjacent the bottom of a well. The conductive material is engaged by an electrical charge from a suitable electrical source. The intensity of the electrical current is sufficient to achieve the desired convective fluid flow in the liquid sample in the well. Usually, the intensity of the electrical current is about 100 μA to about 100 mA. The electrical source may be any electrical source suitable for producing desired electrical charge. Such sources include, for example, DC power supply, chemical battery, and the like.

Other approaches for obtaining the desired convective fluid flow in the liquid samples in the wells include, by way of example and not limitation, movement obtained by application of mechanical energy such as, for example, sonication, diaphragm, vibration, slight movements of substrate or the well housing, application of electric pulses, and so forth. Accordingly, a fluid circulation mechanism of the present apparatus may comprise an audio or sub-audio mechanical impulse or vibration source, an ultrasonic pulse source or continuous wave acoustic source, and so forth.

Each of the components of the present apparatus may be fabricated from any material sufficient to provide a stable structure to each component. Such materials include, for example, metal, plastic, and the like and combinations thereof.

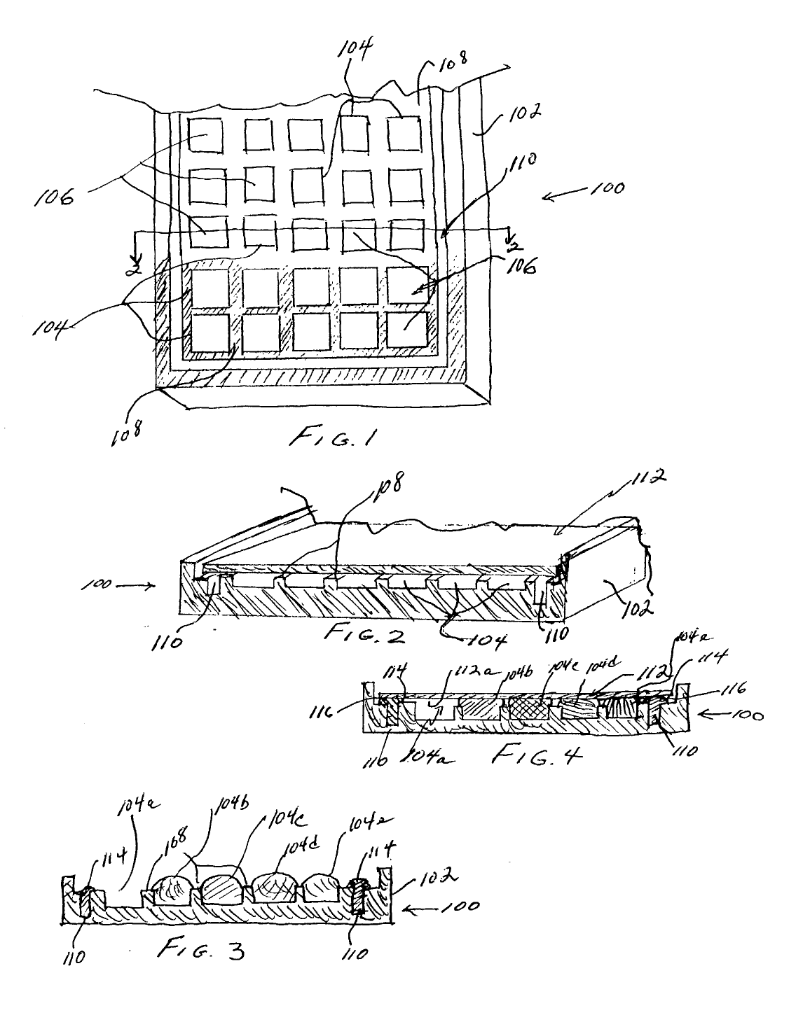

An example of an embodiment of the present invention is depicted in FIG. 1. As a general note, figures are not to scale and some elements of the figures may be accentuated for purposes of illustration. Referring to FIG. 1, an apparatus 100 in accordance with the present invention comprises a housing 102 having a plurality of wells 104 with openings 106 in surface 108 of housing 102. A channel 110 is found on the perimeter of housing 102. Referring to FIG. 2 apparatus 100 is shown with substrate 112 over surface 108. In FIG. 3 apparatus 100 is shown with liquid 114 in channel 110 in an overfill stage where the amount of liquid 114 is sufficient to form a convex meniscus at surface 108 surrounding channel 110. In addition, apparatus 100 is depicted with well 104a empty and with wells 104b to 104e overfilled with liquid samples so that the liquid samples form a convex meniscus. Referring to FIG. 4, apparatus 100 as depicted in FIG. 3 has substrate 112 over surface 108. A fluid seal 116 is formed between surface 112a of substrate 112 at the point of contact of surface 112a and liquid 114. The weight of substrate 112 aids in forming and holding fluid seal 116. Furthermore, the convex meniscus of liquid samples 104b through 104e is depressed without intermingling of the liquid samples in the separate wells.

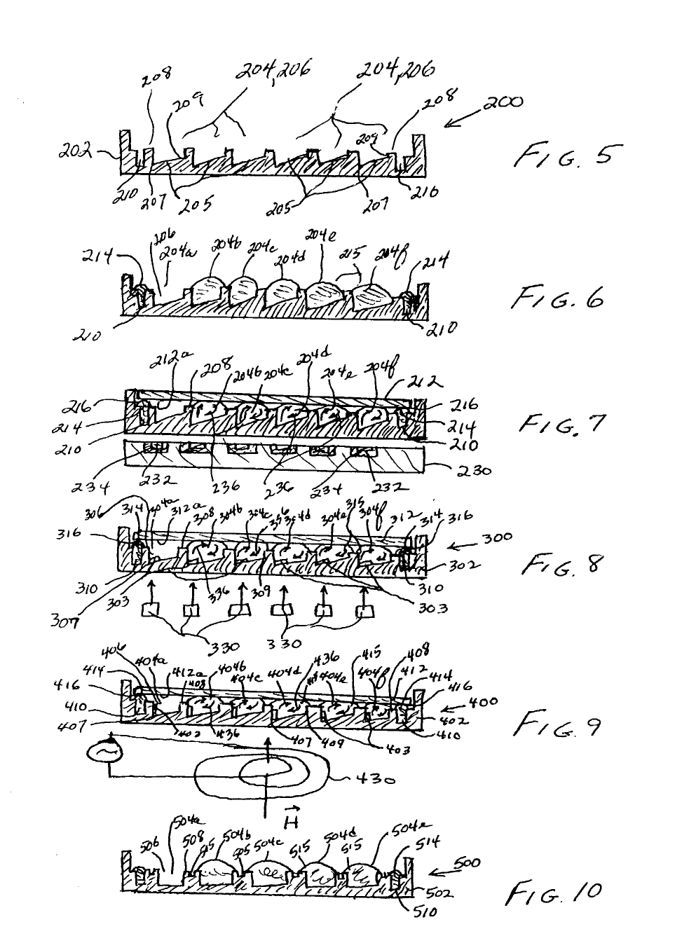

Another embodiment of the present invention is depicted in FIGS. 5-6. Referring to FIG. 5, an apparatus 200 in accordance with the present invention comprises a housing 202 having a plurality of wells 204 (six per row in this embodiment), with openings 206 in surface 208 of housing 202. A channel 210 is found on the perimeter of housing 202. The bottom 205 of wells 204 is sloped so that edge 207 is lower than edge 209. Referring to FIG. 6 apparatus 200 is shown with liquid 214 in channel 210 in an overfill stage where the amount of liquid 214 is sufficient to form a convex meniscus at surface 208 surrounding channel 210. In addition, apparatus 200 is depicted with well 204a empty and with wells 204b to 204f overfilled with liquid samples so that liquid sample in each well forms a convex meniscus.

Referring to FIG. 7, apparatus 200 as depicted in FIG. 6 has substrate 212 over surface 208. A fluid seal 216 is formed between surface 212a of substrate 212 at the point of contact of surface 212a and liquid 214. The weight of substrate 212 aids in forming and holding fluid seal 216. Furthermore, the convex meniscus of liquid samples 204b through 204f is depressed without intermingling of the liquid samples in the separate wells. In FIG. 7, apparatus 200 is shown with heating apparatus 230 beneath apparatus 200. Heating apparatus 230 comprises a plurality of heating elements 232 disposed below respective wells 204. Each heating element 230 is surrounded by insulating material 234. Heating elements 230 are disposed adjacent edge 207 of wells 204. When heating elements 230 are activated, liquid samples 204b to 204f adjacent edge 207 in each of the respective wells are heated and convective mixing 236 occurs. It should be obvious that, since well 204a is empty, no mixing occurs.

Another embodiment of the present invention is depicted in FIG. 8. Referring to FIG. 8, an apparatus 300 in accordance with the present invention comprises a housing 302 having a plurality of wells 304 (six per row in this embodiment), with openings 306 in surface 308 of housing 302. A channel 310 is found on the perimeter of housing 302. The bottom 305 of wells 304 is sloped so that edge 307 is lower than edge 309. Apparatus 300 is shown with liquid 314 in channel 310 in an overfill stage where the amount of liquid 314 is sufficient to form a convex meniscus at surface 308 surrounding channel 310. In addition, apparatus 300 is depicted with well 304a empty and with wells 304b to 304f overfilled with liquid samples so that liquid sample in each well forms a convex meniscus. Apparatus 300 is similar to apparatus 200 with the exception that each of wells 304 in housing 302 has a high emissivity infrared target 303 at edge 307 of wells 304.

As depicted in FIG. 8, apparatus 300 has substrate 312 over surface 308. A fluid seal 316 is formed between surface 312a of substrate 312 at the point of contact of surface 312a and liquid 314. As indicated for previous embodiments, the weight of substrate 312 aids in forming and holding fluid seal 316. Furthermore, the convex meniscus of liquid samples 304b through 304f is depressed without intermingling of the liquid samples in the separate wells. In FIG. 8, apparatus 300 is shown with infrared radiation sources 330 beneath apparatus 300. Infrared radiation sources 330 are disposed below respective high emissivity infrared targets 303 of wells 304. When infrared radiation sources 330 are activated, targets 303 are heated, thus, heating liquid samples 304b to 304f adjacent edge 307 in each of the respective wells. As a result, convective mixing 336 occurs. It should be obvious that, since well 304a is empty, no mixing occurs.

Another embodiment of the present invention is depicted in FIG. 9. Referring to FIG. 9, an apparatus 400 in accordance with the present invention comprises a housing 402 having a plurality of wells 404 (six per row in this embodiment), with openings 406 in surface 408 of housing 402. A channel 410 is found on the perimeter of housing 402. The bottom 405 of wells 404 is sloped so that edge 407 is lower than edge 409. Apparatus 400 is shown with liquid 414 in channel 410 in an overfill stage where the amount of liquid 414 is sufficient to form a convex meniscus at surface 408 surrounding channel 410. In addition, apparatus 400 is depicted with well 404a empty and with wells 404b to 404f overfilled with liquid samples so that liquid sample in each well forms a convex meniscus. Apparatus 400 is similar to apparatus 200 with the exception that each of wells 404 in housing 402 has an eddy current target 403 at edge 407 of wells 404.

As depicted in FIG. 9, apparatus 400 has substrate 412 over surface 408. A fluid seal 416 is formed between surface 412a of substrate 412 at the point of contact of surface 412a and liquid 414. As indicated for previous embodiments, the weight of substrate 412 aids in forming and holding fluid seal 416. Furthermore, the convex meniscus of liquid samples 404b through 404f is depressed without intermingling of the liquid samples in the separate wells. In FIG. 9, apparatus 400 is shown with RF induction heating coil 430 beneath apparatus 400. When coil 430 is activated, targets 403 are heated, thus, heating liquid samples 404b to 404f adjacent edge 407 in each of the respective wells. As a result, convective mixing 436 occurs. It should be obvious that, since well 404a is empty, no mixing occurs.

Another embodiment of the present invention is depicted in FIG. 10. Referring to FIG. 10, an apparatus 500 in accordance with the present invention comprises a housing 502 having a plurality of wells 504 with openings 506 in surface 508 of housing 502. A channel 510 is found on the perimeter of housing 502. Apparatus 500 is shown with liquid 514 in channel 510 in an overfill stage where the amount of liquid 514 is sufficient to form a convex meniscus at surface 508 surrounding channel 510. In addition, apparatus 500 is depicted with well 504a empty and with wells 504b to 504e overfilled with liquid samples so that the liquid samples form a convex meniscus 515. Housing 502 has moats 505 surrounding respective wells 504.

The aforementioned apparatus may be employed in methods for conducting chemical reactions. The chemical reaction can be any chemical reaction that involves chemical reactants in solution and chemical reactants associated with the surface of a substrate or a support. The reactions may involve covalent or non-covalent binding. The chemical reactions may be, for example, reactions between members of a specific binding pair, condensation reactions, oxidation reactions, reduction reactions, displacement reactions, and so forth.

The invention has particular application to binding reactions between members of a specific binding pair. A member of a specific binding pair (“sbp member”) is one of two different molecules, having an area on the surface or in a cavity, which specifically binds to and is thereby defined as complementary with a particular spatial and polar organization of the other molecule. The members of the specific binding pair include ligand and receptor (antiligand). Specific binding pairs include members of an immunological pair such as antigen-antibody, biotin-avidin, hormones-hormone receptors, nucleic acid duplexes, IgG-protein A, polynucleotide pairs such as DNA-DNA, DNA-RNA, and the like.

As mentioned above, hybridization reactions between surface-bound probes and target molecules in solution may be used to detect the presence of particular biopolymers. Hybridization involves members of a specific binding pair that comprises polynucleotides. Hybridization is based on complementary base pairing. When complementary single stranded nucleic acids are incubated together, the complementary base sequences pair to form double stranded hybrid molecules. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

In the methods of the invention, one or more liquid samples are placed in separate wells in a housing surface comprising a plurality of the wells. The liquid samples in each of the wells may be the same or different. The sample may be a trial sample, a reference sample, a combination of the foregoing, or a known mixture of components such as polynucleotides, proteins, polysaccharides and the like (in which case the arrays may be composed of features that are unknown such as polynucleotide sequences to be evaluated). The samples may be from biological assays such as in the identification of drug targets, single-nucleotide polymorphism mapping, monitoring samples from patients to track their response to treatment and/or assess the efficacy of new treatments, and so forth. For hybridization reactions the sample generally comprises a target molecule that may or may not hybridize to a surface-bound molecular probe. The term “target molecule” refers to a known or unknown molecule in a sample, which will hybridize to a molecular probe on a substrate surface if the target molecule and the molecular probe contain complementary regions. In general, the target molecule is a “biopolymer,” i.e., an oligomer or polymer.

The oligomer or polymer is a chemical entity that contains a plurality of monomers. It is generally accepted that the term “oligomers” is used to refer to a species of polymers. The terms “oligomer” and “polymer” may be used interchangeably herein. Polymers usually comprise at least two monomers. Oligomers generally comprise about 6 to about 20,000 monomers, preferably, about 10 to about 10,000, more preferably about 15 to about 4,000 monomers. Examples of polymers include polydeoxyribonucleotides, polyribonucleotides, other polynucleotides that are C-glycosides of a purine or pyrimidine base, or other modified polynucleotides, polypeptides, polysaccharides, and other chemical entities that contain repeating units of like chemical structure or a mixture thereof.

A biomonomer refers to a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

A biopolymer is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

Polynucleotides are compounds or compositions that are polymeric nucleotides or nucleic acid polymers. The polynucleotide may be a natural compound or a synthetic compound. Polynucleotides include oligonucleotides and are comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The polynucleotide can have from about 2 to 5,000,000 or more nucleotides. Usually, the oligonucleotides are at least about 2 nucleotides, usually, about 5 to about 100 nucleotides, more usually, about 10 to about 50 nucleotides, and may be about 15 to about 30 nucleotides, in length. Polynucleotides include single or multiple stranded configurations, where one or more of the strands may or may not be completely aligned with another.

The polynucleotides include nucleic acids, and fragments thereof, from any source in purified or unpurified form including DNA (dsDNA and ssDNA) and RNA, including tRNA, mRNA, rRNA, mitochondrial DNA and RNA, chloroplast DNA and RNA, DNA/RNA hybrids, or mixtures thereof, genes, chromosomes, plasmids, cosmids, the genomes of biological material such as microorganisms, e.g., bacteria, yeasts, phage, chromosomes, viruses, viroids, molds, fungi, plants, animals, humans, and the like. The polynucleotide can be only a minor fraction of a complex mixture such as a biological sample. Also included are genes, such as hemoglobin gene for sickle-cell anemia, cystic fibrosis gene, oncogenes, cDNA, and the like. The polynucleotide can be obtained from various biological materials by procedures well known in the art. A target polynucleotide sequence is a sequence of nucleotides to be identified, detected or otherwise analyzed, usually existing within a portion or all of a polynucleotide.

A nucleotide refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

As explained more fully above, the volume of the liquid sample in each of the wells is sufficient to form a convex meniscus at the surface of each of the wells. The liquid samples are contacted with a substrate surface having a plurality of arrays of chemical compounds arranged on the substrate surface. Each of the arrays corresponds to a respective well in the housing. As a result of the contact, the substrate surface compresses each convex meniscus without cross-contact between adjacent liquid samples.

The support or substrate to which an array or a plurality of arrays of chemical compounds is attached is usually a porous or non-porous water insoluble material. The support can have any one of a number of shapes, usually, a shape that is compatible with the housing comprising the wells. As explained above, the substrate is positioned adjacent the surface of the well housing that comprises the openings to the wells. The well housing may comprise a ridge around its perimeter so that the substrate fits into a recessed area that is the surface of the well housing comprising the openings. However, a ridge is not necessary as long as the substrate may be positioned adjacent the surface comprising the openings so that the respective array or arrays on the substrate surface are aligned with respective wells in the housing. The shape of the substrate may be rectangular, square, oval, circular, and so forth. Portions of the support or the entire surface of the support can be hydrophilic or capable of being rendered hydrophilic or it may be hydrophobic. The support is usually glass such as flat glass whose surface has been chemically activated for binding thereto or synthesis thereon, glass available as Bioglass and the like. However, the support may be made from materials such as inorganic powders, e.g., silica, magnesium sulfate, and alumina; natural polymeric materials, particularly cellulosic materials and materials derived from cellulose, such as fiber containing papers, e.g., filter paper, chromatographic paper, etc.; synthetic or modified naturally occurring polymers, such as nitrocellulose, cellulose acetate, poly (vinyl chloride), polyacrylamide, cross linked dextran, agarose, polyacrylate, polyethylene, polypropylene, poly(4-methylbutene), polystyrene, polymethacrylate, poly(ethylene terephthalate), nylon, both modified and unmodified, poly(vinyl butyrate), etc.; either used by themselves or in conjunction with other materials; ceramics, metals, and the like. Preferably, for packaged arrays the support is a non-porous material such as glass, plastic, metal or the like. In certain embodiments, such as for example where production of binding pair arrays for use in research and related applications is desired, the materials from which the support may be fabricated should ideally exhibit a low level of non-specific binding during hybridization events. In many situations, it will also be preferable to employ a material that is transparent to visible and/or UV light.

The surface of the support onto which polynucleotide compositions or other moieties are deposited or synthesized may be smooth or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethyleneamines, polyarylene sulfides, polysiloxanes, polyimides, polyacetates, and the like, where the polymers may be hetero- or homopolymeric, and may or may not have separate functional moieties attached thereto (for example, conjugated),

The surface of a support is normally treated to create a primed or functionalized surface, that is, a surface that is able to support the synthetic steps involved in the production of arrays of the chemical compound. Functionalization relates to modification of the surface of a support to provide a plurality of functional groups on the support surface. By the term “functionalized surface” is meant a support surface that has been modified so that a plurality of functional groups are present thereon usually at discrete sites on the surface. The manner of treatment is dependent on the nature of the chemical compound to be synthesized and on the nature of the support surface. In one approach a reactive hydrophilic site or reactive hydrophilic group is introduced onto the surface of the support. Such hydrophilic moieties can be used as the starting point in a synthetic organic process.

In one embodiment, the surface of the support, such as a glass support, is siliceous, i.e., comprises silicon oxide groups, either present in the natural state, e.g., glass, silica, silicon with an oxide layer, etc., or introduced by techniques well known in the art. One technique for introducing siloxyl groups onto the surface involves reactive hydrophilic moieties on the surface. These moieties are typically epoxide groups, carboxyl groups, thiol groups, and/or substituted or unsubstituted amino groups as well as a functionality that may be used to introduce such a group such as, for example, an olefin that may be converted to a hydroxyl group by means well known in the art. One approach is disclosed in U.S. Pat. No. 5,474,796 (Brennan), the relevant portions of which are incorporated herein by reference. A siliceous surface may be used to form silyl linkages, i.e., linkages that involve silicon atoms. Usually, the silyl linkage involves a silicon-oxygen bond, a silicon-halogen bond, a silicon-nitrogen bond, or a silicon-carbon bond.

Another method for attachment is described in U.S. Pat. No. 6,219,674 (Fulcrand, et al.). A surface is employed that comprises a linking group consisting of a first portion comprising a hydrocarbon chain, optionally substituted, and a second portion comprising an alkylene oxide or an alkylene imine wherein the alkylene is optionally substituted. One end of the first portion is attached to the surface and one end of the second portion is attached to the other end of the first portion chain by means of an amine or an oxy functionality. The second portion terminates in an amine or a hydroxy functionality. The surface is reacted with the substance to be immobilized under conditions for attachment of the substance to the surface by means of the linking group.

Another method for attachment is described in U.S. Pat. No. 6,258,454 (Lefkowitz, et al.). A solid support having hydrophilic moieties on its surface is treated with a derivatizing composition containing a mixture of silanes. A first silane provides the desired reduction in surface energy, while the second silane enables functionalization with molecular moieties of interest, such as small molecules, initial monomers to be used in the solid phase synthesis of oligomers, or intact oligomers. Molecular moieties of interest may be attached through cleavable sites.

A procedure for the derivatization of a metal oxide surface uses an aminoalkyl silane derivative, e.g., trialkoxy 3-aminopropylsilane such as aminopropyltriethoxy silane (APS), 4-aminobutyltrimethoxysilane, 4-aminobutyltriethoxysilane, 2-aminoethyltriethoxysilane, and the like. APS reacts readily with the oxide and/or siloxyl groups on metal and silicon surfaces. APS provides primary amine groups that may be used to carry out the present methods. Such a derivatization procedure is described in EP 0 173 356 B1, the relevant portions of which are incorporated herein by reference. Other methods for treating the surface of a support will be suggested to those skilled in the art in view of the teaching herein.

The apparatus and methods of the present invention are particularly useful in the analysis of liquid samples comprising biopolymers using substrates comprising an array or a plurality of arrays arranged on the surface of the substrate. An array includes any one, two- or three-dimensional arrangement of addressable regions bearing a particular biopolymer such as polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature. The one or more arrays disposed along a surface of the support are usually separated by inter-array areas. Normally, the surface of the support opposite the surface with the arrays does not carry any arrays.

The surface of the support may carry at least one, two, four, ten, up to thousands of arrays. Depending upon intended use, any or all of the arrays may be the same or different from one another and each may contain multiple spots or features of chemical compounds such as, e.g., biopolymers in the form of polynucleotides or other biopolymer. A typical array may contain more than ten, more than one hundred, more than one thousand, more than ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges.

Each feature, or element, within the molecular array is defined to be a small, regularly shaped region of the surface of the substrate. The features are arranged in a predetermined manner. Each feature of an array usually carries a predetermined chemical compound or mixtures thereof. Each feature within the molecular array may contain a different molecular species, and the molecular species within a given feature may differ from the molecular species within the remaining features of the molecular array. Some or all of the features may be of different compositions. Each array may contain multiple spots or features and each array may be separated by spaces or areas. It will also be appreciated that there need not be any space separating arrays from one another. Interarray areas and interfeature areas are usually present but are not essential. These areas do not carry any chemical compound such as polynucleotide (or other biopolymer of a type of which the features are composed). Interarray areas and interfeature areas typically will be present where arrays are formed by the conventional in situ process or by deposition of previously obtained moieties. In one approach, arrays are synthesized by depositing for each feature at least one droplet of reagent such as from a pulse jet (for example, an inkjet type head) but may not be present when, for example, photolithographic array fabrication processes are used. It will be appreciated though, that the interarray areas and interfeature areas, when present, could be of various sizes and configurations. The primary consideration is that the arrangement of the wells in the well housing and the arrangement of the arrays on the surface of the support are such that a respective array or array feature comes into contact with a respective liquid sample in the wells in a predetermined manner.

The apparatus and methods of the present invention are particularly useful in the analysis of oligonucleotide arrays for determinations of polynucleotides. As explained briefly above, in the field of bioscience, arrays of oligonucleotide probes, fabricated or deposited on a surface of a support, are used to identify DNA sequences in cell matter. The arrays generally involve a surface containing a mosaic of different oligonucleotides or sample nucleic acid sequences or polynucleotides that are individually localized to discrete, known areas of the surface. In one approach, multiple identical arrays across a complete front surface of a single substrate or support are used. However, one or more of the arrays may be different from the other arrays on the substrate surface. Ordered arrays containing a large number of oligonucleotides have been developed as tools for high throughput analyses of genotype and gene expression. Oligonucleotides synthesized on a solid support recognize uniquely complementary nucleic acids by hybridization, and arrays can be designed to define specific target sequences, analyze gene expression patterns or identify specific allelic variations. The arrays may be used for conducting cell study, for diagnosing disease, identifying gene expression, monitoring drug response, determination of viral load, identifying genetic polymorphisms, analyze gene expression patterns or identify specific allelic variations, and the like.

Oligonucleotides are polynucleotides, usually single stranded, either synthetic or naturally occurring. The length of an oligonucleotide is generally governed by the particular role thereof, such as, for example, probe, primer and the like. Various techniques can be employed for preparing an oligonucleotide; such techniques are well known in the art and will not be repeated here. The oligonucleotide can be synthesized by standard methods such as those used in commercial automated nucleic acid synthesizers. Chemical synthesis of DNA on a suitably modified glass or resin can result in DNA covalently attached to the surface. Methods of oligonucleotide synthesis include phosphotriester and phosphodiester methods (Narang, E T al. (1979) Meth. Enzymol 68:90) and synthesis on a support (Beaucage, et al. (1981) Tetrahedron Letters 22:1859-1862) as well as phosphoramidite techniques (Caruthers, M. H., et al., “Methods in Enzymology,” Vol. 154, pp. 287-314 (1988)) and others described in “Synthesis and Applications of DNA and RNA,” S. A. Narang, editor, Academic Press, New York, 1987, and the references contained therein. The chemical synthesis via a photolithographic method of spatially addressable arrays of oligonucleotides bound to glass surfaces is described by A. C. Pease, et al., Proc. Nat. Acad. Sci. USA (1994) 91:5022-5026.

Oligonucleotide probes are oligonucleotides employed to bind to a portion of a polynucleotide such as another oligonucleotide or a target polynucleotide sequence. Usually, the oligonucleotide probe is comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The design, including the length, and the preparation of the oligonucleotide probes are generally dependent upon the sequence to which they bind. Usually, the oligonucleotide probes are at least about 2 nucleotides, preferably, about 5 to about 100 nucleotides, more preferably, about 10 to about 50 nucleotides, and usually, about 15 to about 30 nucleotides, in length.

Various ways may be employed to produce an array of polynucleotides on supports or surfaces such as glass, metal, plastic and the like. Such methods are known in the art. One such method is discussed in U.S. Pat. No. 5,744,305 (Fodor, et al.) and involves solid phase chemistry, photolabile protecting groups and photolithography. Binary masking techniques are employed in one embodiment of the above. Arrays can be fabricated using drop deposition from pulse jets of either polynucleotide precursor units (such as monomers) in the case of in situ fabrication, or the previously obtained polynucleotide. Such methods are described in detail in, for example, U.S. Pat. Nos. 6,242,266, 6,232,072, 6,180,351, 6,171,797 and 6,323,043, U.S. patent application Ser. No. 09/302,898 filed Apr. 30, 1999, by Caren, et al., and the references cited therein, in PCT application WO 89/10977. Other methods include those disclosed by Gamble, et al., WO97/44134; Gamble, et al., WO98/10858; Baldeschwieler, et al., WO95/25116; Brown, et al., U.S. Pat. No. 5,807,522; and the like.

Arrays may be fabricated on the surface of the wells in a manner similar to that described above.

An oligonucleotide probe may be, or may be capable of being, labeled with a reporter group, which generates a signal, or may be, or may be capable of becoming, bound to a support. Detection of signal depends upon the nature of the label or reporter group. Commonly, binding of an oligonucleotide probe to a target polynucleotide sequence is detected by means of a label incorporated into the target. Alternatively, the target polynucleotide sequence may be unlabeled and a second oligonucleotide probe may be labeled. Binding can be detected by separating the bound second oligonucleotide probe or target polynucleotide from the free second oligonucleotide probe or target polynucleotide and detecting the label. In one approach, a sandwich is formed comprised of one oligonucleotide probe, which may be labeled, the target polynucleotide and an oligonucleotide probe that is or can become bound to a surface of a support. Alternatively, binding can be detected by a change in the signal-producing properties of the label upon binding, such as a change in the emission efficiency of a fluorescent or chemiluminescent label. This permits detection to be carried out without a separation step. Finally, binding can be detected by labeling the target polynucleotide, allowing the target polynucleotide to hybridize to a surface-bound oligonucleotide probe, washing away the unbound target polynucleotide and detecting the labeled target polynucleotide that remains. Direct detection of labeled target polynucleotide hybridized to surface-bound oligonucleotide probes is particularly advantageous in the use of ordered arrays.

In one approach, cell matter is lysed, to release its DNA as fragments, which are then separated out by electrophoresis or other means, and then tagged with a fluorescent or other label. The DNA mix is exposed to an array of oligonucleotide probes, whereupon selective attachment to matching probe sites takes place. The array is then washed and the result of exposure to the array is determined. In this particular example, the array is imaged by scanning the surface of the support so as to reveal for analysis and interpretation the sites where attachment occurred.

The signal referred to above may arise from any moiety that may be incorporated into a molecule such as an oligonucleotide probe for the purpose of detection. Often, a label is employed, which may be a member of a signal producing system. The label is capable of being detected directly or indirectly. In general, any reporter molecule that is detectable can be a label. Labels include, for example, (i) reporter molecules that can be detected directly by virtue of generating a signal, (ii) specific binding pair members that may be detected indirectly by subsequent binding to a cognate that contains a reporter molecule, (iii) mass tags detectable by mass spectrometry, (iv) oligonucleotide primers that can provide a template for amplification or ligation and (v) a specific polynucleotide sequence or recognition sequence that can act as a ligand such as for a repressor protein, wherein in the latter two instances the oligonucleotide primer or repressor protein will have, or be capable of having, a reporter molecule and so forth. The reporter molecule can be a catalyst, such as an enzyme, a polynucleotide coding for a catalyst, promoter, dye, fluorescent molecule, chemiluminescent molecule, coenzyme, enzyme substrate, radioactive group, a small organic molecule, amplifiable polynucleotide sequence, a particle such as latex or carbon particle, metal sol, crystallite, liposome, cell, etc., which may or may not be further labeled with a dye, catalyst or other detectable group, a mass tag that alters the weight of the molecule to which it is conjugated for mass spectrometry purposes, and the like.

The signal may be produced by a signal producing system, which is a system that generates a signal that relates to the presence or amount of a target polynucleotide in a medium. The signal producing system may have one or more components, at least one component being the label. The signal producing system includes all of the reagents required to produce a measurable signal. The signal producing system provides a signal detectable by external means, by use of electromagnetic radiation, desirably by visual examination. Signal-producing systems that may be employed in the present invention are those described more fully in U.S. Pat. No. 5,508,178, the relevant disclosure of which is incorporated herein by reference.

The arrays and the liquid samples in the wells are maintained in contact for a period of time sufficient for the desired chemical reaction to occur. The conditions for a reaction, such as, for example, period of time of contact, temperature, pH, salt concentration and so forth, are dependent on the nature of the chemical reaction, the nature of the chemical reactants including the liquid samples, and the like. The conditions for binding of members of specific binding pairs are generally well known and will not be discussed in detail here.

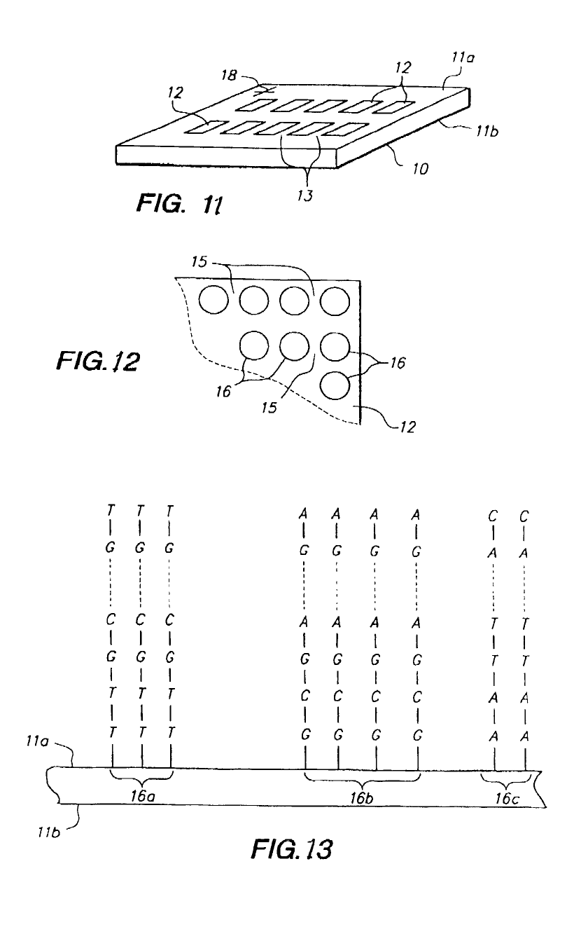

Referring to FIGS. 11-13, there is shown multiple identical arrays 12 (only some of which are shown in FIG. 11), separated by inter-array regions 13, across the complete front surface 11a of a single transparent substrate 10. However, the arrays 12 on a given substrate need not be identical and some or all could be different. Each array 12 will contain multiple spots or features 16 separated by inter-feature regions 15. A typical array 12 may contain from 100 to 100,000 features. All of the features 16 may be different, or some or all could be the same. Each feature carries a predetermined moiety (such as a particular polynucleotide sequence), or a predetermined mixture of moieties (such as a mixture of particular polynucleotides). This is illustrated schematically in FIG. 3 where different regions 16 are shown as carrying different polynucleotide sequences.

As mentioned above, the present apparatus and methods are particularly suitable for use in methods for analyzing the results of hybridization reactions. Such reactions are carried out on a substrate or support comprising a plurality of features relating to the hybridization reactions. The substrate is exposed to liquid samples in the wells of the present apparatus and to other reagents for carrying out the hybridization reactions. The support surface exposed to the sample is incubated under conditions suitable for hybridization reactions to occur. The parameters for such conditions are well known in the art and will not be repeated here.

After the appropriate period of time of contact between the liquid samples in the wells and the arrays on the surface of the substrate, the contact is discontinued. The substrate is moved to an examining device where the surface of the substrate on which the arrays are disposed is interrogated. The examining device may be a scanning device involving an optical system.

Reading of the array may be accomplished by illuminating the array and reading the location and intensity of resulting fluorescence at each feature of the array. For example, a scanner may be used for this purpose where the scanner may be similar to, for example, the AGILENT MICROARRAY SCANNER available from Agilent Technologies Inc, Palo Alto, Calif. Other suitable apparatus and methods are described in U.S. patent applications Ser. No. 09/846,125 “Reading Multi-Featured Arrays” by Dorsel, et al.; and Ser. No. 09/430,214 “Interrogating Multi-Featured Arrays” by Dorsel, et al. The relevant portions of these references are incorporated herein by reference. However, arrays may be read by methods or apparatus other than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature that is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

In another particular embodiment, the method is carried out under computer control, that is, with the aid of a computer. For example, an IBM® compatible personal computer (PC) may be utilized. The computer is driven by software specific to the methods described herein. The preferred computer hardware capable of assisting in the operation of the methods in accordance with the present invention involves a system with at least the following specifications: Pentium® processor or better with a clock speed of at least 100 MHz, at least 32 megabytes of random access memory (RAM) and at least 80 megabytes of virtual memory, running under either the Windows 95 or Windows NT 4.0 operating system (or successor thereof).

Software that may be used to carry out the methods may be, for example, Microsoft Excel or Microsoft Access, suitably extended via user-written functions and templates, and linked when necessary to stand-alone programs that perform homology searches or sequence manipulations. Examples of software or computer programs used in assisting in conducting the present methods may be written, preferably, in Visual BASIC, FORTRAN and C⁺⁺, as exemplified below in the Examples. It should be understood that the above computer information and the software used herein are by way of example and not limitation. The present methods may be adapted to other computers and software. Other languages that may be used include, for example, PASCAL, PERL or assembly language.

As indicated above, a computer program may be utilized to carry out the above method steps. The computer program provides for (i) placing one or more liquid samples in separate wells in a housing surface comprising a plurality of the wells wherein the volume of the liquid sample in each of the wells is sufficient to form a convex meniscus at the surface of each of the wells, and (ii) contacting the liquid samples with a substrate surface having a plurality of arrays of chemical compounds arranged on the substrate surface wherein each of the arrays corresponds to a respective well in the housing and wherein the substrate surface compresses each convex meniscus without cross-contact between adjacent liquid samples. Optionally, the computer program may provide for forming a seal between the substrate surface and the housing surface around the perimeter of the wells during the above contacting.

Another aspect of the present invention is a computer program product comprising a computer readable storage medium having a computer program stored thereon which, when loaded into a computer, performs the aforementioned method.

One aspect of the invention is the product of the above method, namely, the assay result, which may be evaluated at the site of the testing or it may be shipped to another site for evaluation and communication to an interested party at a remote location if desired. By the term “remote location” is meant a location that is physically different than that at which the results are obtained. Accordingly, the results may be sent to a different room, a different building, a different part of city, a different city, and so forth. Usually, the remote location is at least about one mile, usually, at least ten miles, more usually about a hundred miles, or more from the location at which the results are obtained. The data may be transmitted by standard means such as, e.g., facsimile, mail, overnight delivery, e-mail, voice mail, and the like.

“Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

A particular embodiment of the present invention is a method of testing multiple liquid samples with multiple biopolymer arrays. Each of the multiple liquid samples is placed in all or less than all of the separate wells in a housing surface comprising a plurality of the wells. The volume of the liquid sample in each of the wells is sufficient to form a convex meniscus at the surface of each of the wells and the bottom of the wells is slanted. Liquid is placed in a channel in the housing surface surrounding the wells wherein the amount of the liquid is sufficient to form a convex meniscus. The liquid samples are contacted with a substrate surface having multiple biopolymer arrays arranged on the substrate surface. Each of the arrays corresponds to a respective well in the housing. The substrate surface compresses each convex meniscus without cross-contact between adjacent liquid samples. In addition, a seal is formed between the substrate surface and the housing surface around the perimeter of the wells. Heat is applied to the liquid samples sufficient to cause circulation in the samples. The substrate surface is then observed for the presence of reactions between the biopolymer arrays and the liquid samples.

Another embodiment of the present invention is a kit for analyzing multiple biopolymer arrays on the surface of a substrate. The kit comprises in packaged combination an apparatus for conducting chemical reactions and a substrate having on a surface thereof a plurality of biopolymer arrays. The apparatus comprises a plurality of wells in a housing and a channel in the housing. The channel surrounds the plurality of wells and is adapted for being filled with an amount of a fluid to form a convex meniscus extending above the top of the channel. Optionally, the kit may comprise other reagents for the binding or other reactions involved. In one embodiment, the kit may further include a hybridization kit for conducting hybridization reactions. The kit may further include a dye for the detection step. The kit may also include a written description of a method in accordance with the present invention and instructions for carrying out such method.

It should be understood that the above description is intended to illustrate and not limit the scope of the invention. Other aspects, advantages and modifications within the scope of the invention will be apparent to those skilled in the art to which the invention pertains. The following examples are put forth so as to provide those of ordinary skill in the art with examples of how to make and use the method and products of the invention, and are not intended to limit the scope of what the inventors regard as their invention.

All publications and patent applications cited in this specification are herein incorporated by reference as if each individual publication or patent application were specifically and individually indicated to be incorporated by reference, except insofar as they may conflict with those of the present application (in which case the present application prevails). Methods recited herein may be carried out in any order of the recited events which is logically possible, as well as the recited order of events.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. An apparatus for conducting chemical reactions, said apparatus comprising:
(a) a plurality of wells in a housing and
(b) a channel in said housing, said channel surrounding said plurality of wells and adapted for being filled with an amount of a fluid to form a convex meniscus extending above the top of said channel.

2. An apparatus according to claim 1 wherein said plurality of wells is in the form of a pattern in said housing.

3. An apparatus according to claim 1 wherein each of said wells has variable depth.

4. An apparatus according to claim 3 wherein each of said wells has a fluid circulation mechanism associated therewith.

5. An apparatus according to claim 4 wherein said fluid circulation mechanism comprises a member selected from the group consisting of sources for generating a thermal gradient causing convective flow and sources of mechanical energy.

6. An apparatus according to claim 5 wherein said member is a source for generating a thermal gradient selected from the group consisting of electrical current sources, infrared radiation sources, radio frequency sources, electrical resistance heaters, and semiconductor junction heaters, and Peltier cooling devices or said member is a source of mechanical energy selected from the group consisting of electric pulses, audio mechanical pulses, sub-audio mechanical impulses, vibration sources, ultrasonic pulses, and continuous wave acoustic sources.

7. An apparatus according to claim 1 wherein the surface properties surrounding each of said wells is different than the surface properties of said wells.

8. An apparatus according to claim 1 wherein each of said wells has a groove around its perimeter.

9. A method for conducting chemical reactions, said method comprising:
(a) placing one or more liquid samples in separate wells in a housing surface comprising a plurality of said wells wherein the volume of said liquid sample in each of said wells is sufficient to form a convex meniscus at the surface of each of said wells, and
(b) contacting said liquid samples with a plurality of arrays of chemical compounds wherein each of said arrays corresponds to a respective well in said housing.

10. A method according to claim 9 wherein said liquid samples are contacted with a substrate surface having a plurality of arrays of chemical compounds arranged on said substrate surface wherein each of said arrays corresponds to a respective well in said housing and wherein said substrate surface compresses each convex meniscus without cross-contact between adjacent liquid samples.

11. A method according to claim 10 further comprising, during said contacting, forming a seal between said substrate surface and said housing surface around the perimeter of said wells.

12. A method according to claim 11 wherein said seal is selected from the group consisting of fluid seals and seals is formed by placing a liquid in a channel in said housing surface surrounding said wells prior to contacting said substrate surface with said housing surface wherein the amount of said liquid is sufficient to form a convex meniscus.

13. A method according to claim 10 wherein said plurality of wells is in the form of a pattern in said housing.

14. A method according to claim 10 further comprising circulating said liquid sample in each of said wells.

15. A method according to claim 14 wherein the bottom of said wells is slanted and said method further comprises a step generating a thermal gradient causing convective flow in said liquid samples or a step of applying mechanical energy to said liquid samples sufficient to cause circulation therein.

16. A method according to claim 15 wherein said step is generating a thermal gradient causing convective flow selected from the group of steps consisting of (i) applying heat to said liquid samples sufficient to cause circulation in said samples from a heat source selected from the group consisting of electrical current sources, infrared radiation sources, radio frequency sources, electrical resistance heaters, and semiconductor junction heaters, and (ii) cooling said samples by means of a Peltier cooling device sufficient to cause circulating in said liquid samples or said step is applying mechanical energy selected from the group of steps consisting of (i) applying an electrical pulse to said liquid samples sufficient to cause circulating in said liquid samples, (ii) applying an audio or sub-audio mechanical impulse or vibration to said liquid samples sufficient to cause circulating in said liquid samples, and (iii) applying an ultrasonic pulse or continuous wave acoustic signal to said liquid samples sufficient to cause circulating in said liquid samples.

17. A method according to claim 10 wherein the surface properties surrounding each of said wells is different than the surface properties of said wells.

18. A method according to claim 10 wherein each of said wells has a groove around its perimeter.

19. A method according to claim 10 wherein said chemical reactions involve biopolymers.

20. A method according to claim 10 further comprising reading the arrays.

21. A method according to claim 20 comprising forwarding data representing a result obtained from reading one of the arrays.

22. A method according to claim 21 wherein the data is transmitted to a remote location.

23. A method according to claim 21 comprising receiving data representing a result of an interrogation obtained by reading one of the arrays.

24. A method of testing multiple liquid samples with multiple biopolymer arrays, said method comprising:
(a) placing each of a multiple liquid samples in all or less than all separate wells in a housing surface comprising a plurality of said wells wherein the volume of said liquid sample in each of said wells is sufficient to form a convex meniscus at the surface of each of said wells, wherein the bottom of said wells is slanted,
(b) placing a liquid in a channel in said housing surface surrounding said wells wherein the amount of said liquid is sufficient to form a convex meniscus,
(c) contacting said liquid samples with a substrate surface having multiple biopolymer arrays arranged on said substrate surface wherein each of said arrays corresponds to a respective well in said housing and wherein said substrate surface compresses each convex meniscus without cross-contact between adjacent liquid samples and wherein forming a seal between said substrate surface and said housing surface around the perimeter of said wells,
(d) causing circulation in said liquid samples, and
(e) observing said substrate surface for the presence of reactions between said biopolymer arrays and said liquid samples.

25. A method according to claim 24 wherein said plurality of wells is in the form of a pattern in said housing.

26. A method according to claim 24 wherein said circulation is caused by generating a thermal gradient causing convective flow in said liquid samples or by applying mechanical energy to said liquid samples sufficient to cause circulation therein.

27. A method according to claim 26 wherein said circulation is caused by generating a thermal gradient causing convective flow selected from the group of steps consisting of (i) applying heat to said liquid samples sufficient to cause circulation in said samples from a heat source selected from the group consisting of electrical current sources, infrared radiation sources, radio frequency sources, electrical resistance heaters, and semiconductor junction heaters, and (ii) cooling said samples by means of a Peltier cooling device sufficient to cause circulating in said liquid samples or said circulation is caused applying mechanical energy selected from the group of steps consisting of (i) applying an electrical pulse to said liquid samples sufficient to cause circulating in said liquid samples, (ii) applying an audio or sub-audio mechanical impulse or vibration to said liquid samples sufficient to cause circulating in said liquid samples, and (iii) applying an ultrasonic pulse or continuous wave acoustic signal to said liquid samples sufficient to cause circulating in said liquid samples.

28. A method according to claim 24 wherein the surface properties surrounding each of said wells is different than the surface properties of said wells.

29. A method according to claim 24 wherein each of said wells has a groove around its perimeter.

30. A method according to claim 24 wherein said biopolymers are polynucleotides or polypeptides.

31. A kit for analyzing multiple biopolymer arrays on the surface of a substrate, said kit comprising in packaged combination:
(a) an apparatus for conducting chemical reactions, said apparatus comprising:
(i) a plurality of wells in a housing and
(ii) a channel in said housing, said channel surrounding said plurality of wells and adapted for being filled with an amount of a fluid to form a convex meniscus extending above the top of said channel, and
(b) a substrate having on a surface thereof a plurality of biopolymer arrays.

32. A method for conducting chemical reactions, said method comprising:
(a) placing one or more liquid samples in separate wells in a housing surface comprising a plurality of said wells wherein each of the wells has a depth which varies within the well, and
(b) contacting said liquid samples with a plurality of arrays of chemical compounds wherein each of said arrays corresponds to a respective well in said housing.

33. A method according to claim 32 wherein said liquid samples are contacted with a substrate surface placed over well openings, and which surface has the plurality of arrays of chemical compounds arranged on said substrate surface.
